(19) United States
(12) Patent Application Publication
(10) Pub. No.: US 2019/0378078 A1
(43) Pub. Date: Dec. 12, 2019

(54) TASK DELEGATION SYSTEM

(71) Applicant: INTYRN INC, Claymont, DE (US)

(72) Inventor: Mícheál Áristeía-Æsír, Claymont, DE (US)

(21) Appl. No.: 16/438,021

(22) Filed: Jun. 11, 2019

Related U.S. Application Data
(60) Provisional application No. 62/683,597, filed on Jun. 11, 2018.

(51) Int. Cl. G06Q 10/06

(52) U.S. Cl. CPC G06Q 10/063112; G06Q 10/063114

(57) ABSTRACT

Disclosed is a method for assigning tasks to service providers. A task request with task parameters is received from a user-operated user device. A search is then performed for service provider profiles within a trust circle associated with the user. The trust circle contains service providers who have previously worked with the user and service providers who have been referred by vetted individuals or other service providers in the trust circle. The returned service provider profiles are then presented to the user device.

### CROSS-REFERENCE TO RELATED APPLICATION(S)

This application claims priority to U.S. Provisional Application Ser. No. 62/683,597, entitled “FUNDING SYSTEM FOR PHILANTHROPIC VENTURES” filed Jun. 11, 2018, which is hereby incorporated by reference in its entirety.

### TECHNICAL FIELD

The disclosure generally relates to the matching of a task to a person or group.

### BACKGROUND

The workforce has increasingly shifted from traditional employment toward independent contracting and the “gig economy.” Instead of receiving hourly wages or salary, these independent contractors are paid for completing discrete tasks, such as delivering a meal or transporting a passenger. Mobile applications like Uber, Lyft, DoorDash, and many others have driven this shift by making it easy to connect users requesting services and contractors performing the services.

However, one problem with existing gig economy apps is the inability for users to connect with trusted service providers. This has resulted, for example, in multiple news stories relating to crimes committed by Uber drivers. While most gig economy apps require general background checks for service providers, these checks are insufficient. Sometimes tasks like food delivery will not require a trusted relationship between the user and delivery-person, but tasks that are more personal, such as counseling or childcare, require a higher level of trust. Similarly, users requesting tasks that require a higher level of expertise, such as legal consultation, also benefit from more trust in the service provider.

### SUMMARY

The disclosed embodiments match a user's task request with one or more service providers to complete a task. A task request may include multiple parameters, including but not limited to, a desired price, time, place, or type of task. Embodiments establish trust between a user requesting a task and service providers by building a trust circle for the user. After receiving a task request from a user device associated with a user, a server may then search for profiles of service providers within the trust circle that match the task request. The profiles of the trusted service providers that match the task request may then be presented to the user for their selection. The trust circle benefits both the user and the service provider. The user benefits by knowing that a trusted service provider will complete their task, ensuring higher confidence that the work will be satisfactory. The service provider benefits by receiving special status in search results and by establishing a relationship with the user, thereby generating repeat business.

The trust circle may contain service providers who have previously worked with the user as well as service providers recommended by vetted individuals. In some embodiments, the vetted individual may include friends or family of the user on linked social media networks. The trust circle may be expanded by a referral process, where a service provider in the trust circle may refer other service providers to the user. This process results in chains of service providers where each service provider in a chain has a responsibility to the others in the chain. A service provider may be removed from the trust circle. For example, a service provider who breaches an ethical, moral, or business obligation may be removed from the trust circle according to the severity of the breach. Further, removal of a service provider can also lead to removal of other service providers, such as a connected service provider who can be a service provider referred by or who referred the removed service provider. For example, a serious breach by a service provider may also result in the removal of other service providers in the chain. This incentivizes service providers to only refer others whom they have high confidence in and encourages the integrity of all members of the trust circle.

### BRIEF DESCRIPTION OF THE DRAWINGS

FIG. 1 is a block diagram of a system for assigning tasks to a service provider, consistent with various embodiments.

FIG. 2 shows an example trust circle according to various embodiments.

FIG. 3 is a flow diagram of a method for matching a task request to a service provider according to various embodiments.

FIG. 4 shows a method for searching service provider profiles, consistent with various embodiments.

FIG. 5 is a flow diagram of a method for managing a trust circle, consistent with various embodiments.

FIG. 6A is screenshot of a search GUI of the task management application, consistent with various embodiments.

FIG. 6B is screenshot of a voice GUI of the task management application, consistent with various embodiments.

FIG. 6C is screenshot of a chat GUI of the task management application, consistent with various embodiments.

FIG. 7A is screenshot of a profile GUI of the task management application, consistent with various embodiments.

FIG. 7B is screenshot of an extended profile GUI of the task management application, consistent with various embodiments.

FIG. 8 is a diagrammatic representation of a machine in the example form of a computer system within which a set of instructions for causing the machine to perform any one or more of the methods discussed herein may be executed.

### DETAILED DESCRIPTION

### Overview

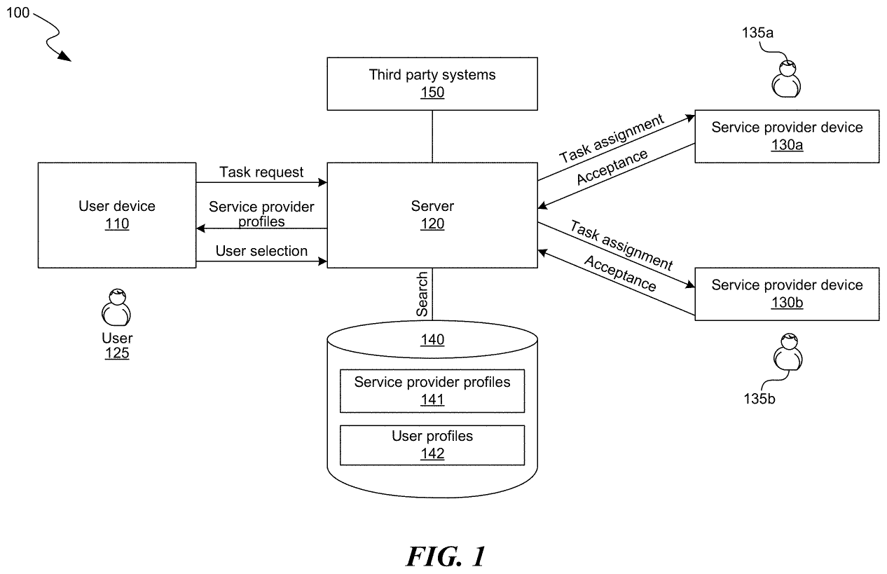

FIG. 1 is a block diagram of a system 100 for assigning tasks to a service provider, consistent with various embodiments. The system 100 may include a user device 110 associated with a user 125, a server 120, one or more service provider devices 130 associated with corresponding service providers 135a and 135b, a storage system 140, and third-party systems 150. The user device 110, server 120, service provider devices 130, storage system 140, and third-party systems 150 may communicate over a network.

The user device 110 may be used by the user 125 to request a service provider for performing a task. An example task can include delivering food, providing a ride, shipping packages/documents, or running errands. The user device 110 may be any device capable of communicating over a network, such as a mobile phone, tablet, or personal computer. Each user may create a user profile 142 using the user device 110, which may then be transmitted through a network and stored in the storage system 140.

The service provider devices 130, which include service provider device 130a and service provider device 130b, are devices used by service providers 135a and 135b, e.g., a person or another entity who provides a service. Each service provider device 130 may execute an application that facilitates communication with any of the server 120, storage system 140, or user device 110. The service provider devices 130 may each be any device capable of communicating over a network, such as a mobile phone, tablet, or personal computer. Each service provider may create a service provider profile using the service provider device 130, which may then be transmitted through a network and stored in storage system 140.

The storage system 140 stores a variety of information, including a service provider profile 141 and user profile 142. The service provider profile 141 may contain information such as contact information, types of tasks a service provider is willing to perform, and prices the service provider charges for each type of task. The service provider profile 141 may be linked to a calendar, enabling the server 120 to identify the service provider's availability to complete requested tasks at specified times. The service provider profile 141 may also contain evidence of degrees, certifications or licenses that qualify the service provider for particular types of tasks. For example, the service provider profile 141 may contain evidence indicating that the service provider is a college graduate, certified electrician, or licensed attorney. The service provider profile 141 may also contain a user rating associated with feedback from performing tasks. The user rating may be an average of numerical scores received from users whom the service provider has completed tasks for.

The storage system 140 may also contain user profile 142. The user profile 142 may contain information related to a user and task requests from the user, including contact information for the user, financial account information, and user preferences such as favorite food, preferred contact method, preferred attributes in a service provider.

The server 120 can execute a task management application that facilitates assignment of task requests to service providers. The task management application can be accessed from a user device 110 via a web browser executing on the user device 110. In some embodiments, the task management application can include a server portion that is executing at the server 120 and a client portion, which executes as an “app” on the user device 110. The server 120 receives a task request from the user device 110. The task request may be a text or voice request. For example, the user 125 may dictate a request into the microphone of their mobile phone or use a keyboard to fill out a graphical user interface (GUI) built into the task management application. The task request may have task parameters, including but not limited to, a price offered by the user for performing the task, a location where task should be performed, types of tasks, time requirements, level of expertise required, number of service providers required, and whether or not a trusted service provider is needed. For example, the task request may include delivery of a home-cooked meal by 5 PM from a trusted professional chef, with a price limit of $30. The server 120 will then search the storage system 140 for service provider profiles based on those task parameters. Additionally, the server 120 may also consider information from the user profile 142 when performing the search. For example, the server 120 may consider a user's favorite food when performing a search if no food is specified in the task parameters of a task request. The server 120 determines the service providers that match the task request and presents the search result, e.g., profiles of matching service providers such as service providers 135a and 135b, on the user device 110.

The user 125 can select at least one of the matching service providers, such as the service provider 135a, which is transmitted to the server 120. Upon receiving the user selection of the service provider 135a from the user device 110, the server 120 can assign the task to the service provider 135a by transmitting the task request to the service provider device 130a. After receiving the task assignment, the service provider 135a may choose to accept or decline the task request.

The server 120 may receive a variety of information from third-party systems 150 that can facilitate in various aspects of task assignments. For example, the information may include news reports, information from social media sites, or court filings. The third-party systems 150 may include but are not limited to, websites, databases, or even people with computing devices. For example, the third-party systems 150 may include Twitter feeds or local news websites. The third-party systems 150 may be connected to the server 120 over a network. In some embodiments, the information may be used by the server 120 to manage the trust circle, including determining whether to remove a service provider from the trust circle, adding service providers to the trust circle or retaining service providers in the trust circle. In some embodiments, the server may analyze information from third-party systems 150 using artificial intelligence techniques. For example, the server 120 could receive a news story reporting a drunk-driving incident involving a service provider. An artificial intelligence model could then analyze whether the service provider was at fault based on the story and accordingly decide whether or not to remove the service provider from the trust circle.

### Building a Trust Circle

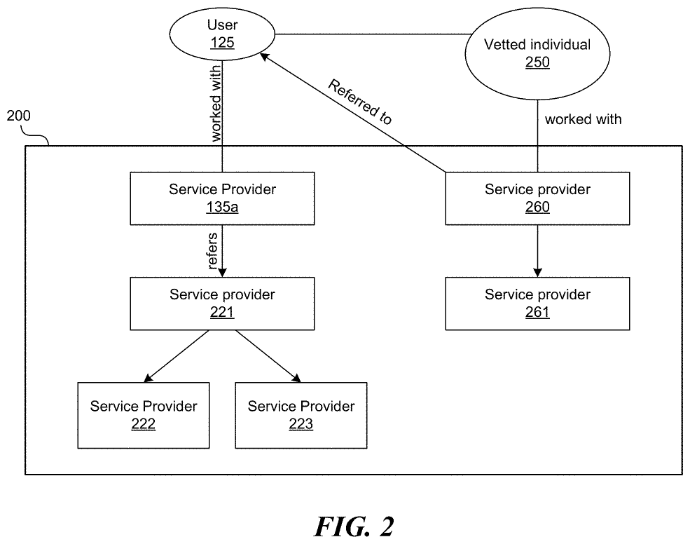

FIG. 2 shows an example trust circle 200 according to various embodiments. The trust circle 200 is associated with the user 125. The trust circle 200 may include service providers who have previously worked with the user 125, such as a service provider 135a. Information regarding the trust circle 200, such as the user with which the trust circle 200 is associated and/or which service providers are within the trust circle 200 may be stored in the storage system 140.

In some embodiments, the trust circle 200 may include service providers who have previously worked with a vetted individual 250 associated with the user 125, such as a service provider 260, and referred by the vetted individual 250 to the user 125. The vetted individual 250 may be a friend, family member, or other individual associated the user 125. In some embodiments, the user 125 directly chooses the vetted individual 250. In other embodiments, the user 125 and the vetted individual 250 are linked implicitly, e.g., the user 125 and the vetted individual 250 are friends on a social network. In some embodiments, an implicit connection between the user 125 and the vetted individual 250 may be derived from a third-party system 150, such as Facebook. In some embodiments, the user 125 and the vetted individual 250 are linked explicitly, e.g., the user 125 may have referred the vetted individual 250 to the task management application or a friend of the user 125 in the task management application, or the user 125 may have explicitly endorsed the vetted individual 250 in the task management application.

Service providers outside the trust circle 200 may be added to the trust circle 200 after completing a task for the user 125. Service providers outside the trust circle 200 may also be added to trust circle 200 if they complete a task for the vetted individual 250 and are referred to the user 125 by the vetted individual 250. In some embodiments, service providers may also be required to complete a task for the user 125 or the vetted individual 250 before being added to the trust circle 200. Similarly, service providers may also be required to receive an above-threshold review rating from the user 125 or the vetted individual 250 before being added to the trust circle. The users may provide a review rating that can be indicative of a quality of the service provided by a service provider in performing the assigned task. The review rating can be any predetermined scale, e.g., a scale of 1-5 where is “1” is indicative of a lowest quality of service and “5” is indicative of a high quality of service. In some embodiments, the service provider 135a may have to a review rating of above “3” to be entered into or remain in the trust circle 200.

The trust circle 200 may also include a service provider 221, who was referred by service provider 135a, and a service provider 261, who was referred by service provider 260. Further, the trust circle 200 may include service providers 222 and 223, who were referred by the service provider 221. Any service provider in the trust circle 200 may refer any number of additional service providers to be added to the trust circle. Furthermore, any additional service providers may subsequently refer even more service providers from outside the trust circle. This process may be iterated to form “chains” of service providers in the trust circle. For example, service provider 135a, service provider 221, and service provider 223 form one chain, which can be extended by referrals from service provider 223, and the service provider 260 (referred by the vetted individual 250) and the service provider 261 referred by the service provider 260 can form a second chain. In some embodiments, the server 120 may allow a first service provider to refer a second service provider to the user 125 if the first service provider has previously provided a service for the user 125.

In some embodiments, the service providers in the trust circle 200 are given a priority over the service providers outside the trust circle 200 for task assignment by the server 120. Accordingly, it is an incentive for the service providers to be in the trust circle of a user. Further, service providers in the trust circle 200 may be incentivized to refer other service providers to the trust circle 200. In some embodiments, service providers in the trust circle 200 may receive income based on the revenue earned by their connected service providers. “Connected service provider” indicates a service provider who was referred to the user 125 by another service provider. Service providers may receive the income on a limited basis, for example receiving a bonus after their connected service provider completes their first task for the user who's associated with the trust circle. The income may alternatively or additionally be ongoing, for example the referring service provider may receive income equal to a percentage of all revenue earned by a portion of their connected service providers.

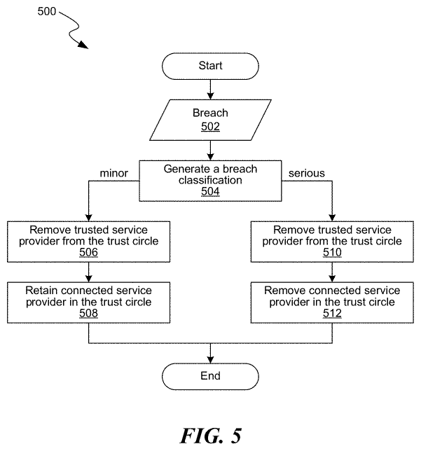

Besides these positive incentives, there may also be penalties for service providers in the trust circle 200. For example, a service provider may be removed from the trust circle 200 if a trust rating of the service provider drops below a threshold, as described in detail at least with reference to FIG. 5. In another example, a service provider may be removed from the trust circle 200 if they do not make a certain number of referrals in a specified amount of time.

### Assignment Process

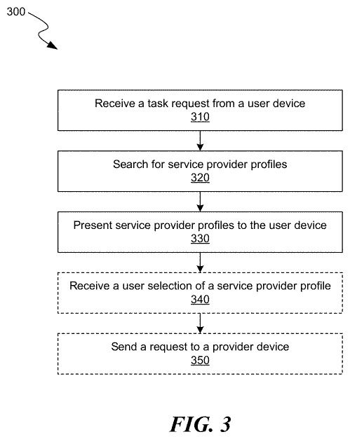

FIG. 3 is a flow diagram of a method 300 for matching a task request to a service provider according to various embodiments. In some embodiments, the method 300 may be implemented using the system 100 of FIG. 1. The method 300 begins at block 310, where the server 120 receives a task request from a user device, such as the user device 110. The server 120 may receive the task request over a network. The task request may include various task parameters, such as price, a location where the task should be performed, types of tasks, time requirements such as when and a duration of the task, level of expertise required, number of service providers required, and whether or not a trusted service provider is needed.

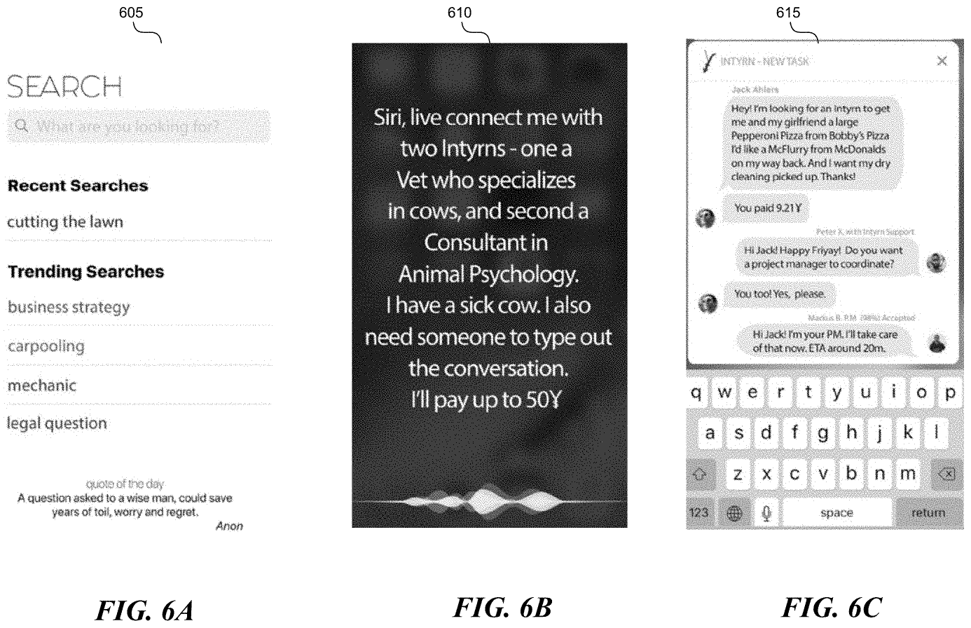

The user 125 may provide the task request in various ways. For example, the user 125 may issue a task request using a search GUI of the task management application executing at the user device 110, as illustrated in FIG. 6A. In another example, the user 125 may provide the task request as a voice request by speaking to the user device 110, as illustrated in FIG. 6B. A voice assistant associated with the user device 110 or the task management application can interpret the voice to generate the task request. In another example, the user 125 may issue a task request via chat messages in the task management application, as illustrated in FIG. 6C.

At block 320, the server 120 executes a search at the storage system 140 for service provider profiles, e.g., from service provider profile 141, using the task parameters received at block 310 to find service provider profiles of the service providers that satisfy a search criterion. The search criterion may consider all task parameters or some of the task parameters in performing the search. When performing the search, the server 120 may not have to look for service provider profiles who exactly match the task parameters. For example, the server 120 may be unable to identify a task parameter from the task request or information regarding a particular task parameter may be missing from a service provider profile. The server 120 may also search service provider profiles using task parameters that vary from the task parameters provided by the user. However, the server may prioritize profiles that more closely match the user-provided task parameters. For example, if a price offered for a task, such as “$50,” is one of the task parameters specified by the user 125 in the task request and if no service providers are available to perform a task for $50, the server 120 may indicate to the user 125 that no service provers are available at that price. However, in some embodiments, the server 120 may also search for service providers that offer the service at a higher price, e.g., “$60,” and present those results to the user device 110. In some embodiments, the user 125 may specify in their task request not to search outside the bounds of their provided task parameters.

In some embodiments, a task parameter may be implicit. For example, a task parameter such as a location of the task to be performed may be implicitly derived from location services of the user device 110 or an IP address of the user device 110. Continuing with the example, the location can be an address of the user 125 requesting the task, and the server 120 may restrict the search to find service providers who provide services in the proximity of the address, e.g., in a zip code of the address.

In some embodiments, the server 120 will search service provider profiles of service providers that are in a trust circle associated with the user, e.g., trust circle 200 associated with the user 125. The server 120 may also search service provider profiles outside the trust circle, for example if the search does not yield any results for service providers in the trust circle 200 that match one or more task parameters. In some embodiments, the server 120 may search service provider profiles outside the trust circle 200 if the user 125 has indicated in the task request for the search to be performed outside the trust circle as well.

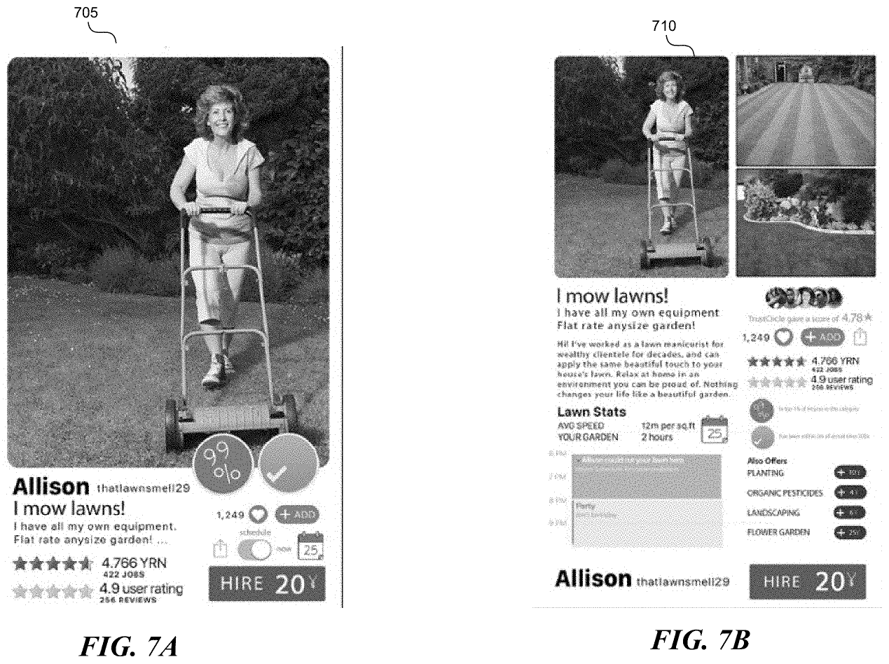

At block 330, the server 120 presents service provider profiles to the user device. These profiles correspond to the service providers returned during the search performed as part of block 320. The server 120 transmits the service provider profiles to the user device 110. The service provider profiles may be presented in various forms, such as lists, icons, tiles, or individual profiles in a GUI on the user device 110. In some embodiments, the service provider profiles are presented one-by-one, wherein the user may browse the profiles by providing input to the user device 110 in the form of gestures, such as swiping. In other embodiments, the service provider profiles may be presented as tiles on a computer screen, wherein the user 125 may click on the tile to view the service provider profile in more detail. A service provider profile presented on the user device 110 can include information associated with a service provider such as a name, contact information, date and time of availability, a picture of the service provider, cost of the service, certifications, or expertise, as illustrated in FIGS. 7A and 7B.

The user 125 may review the service provider profiles presented on the user device 110 and may choose to assign the task to one of the service providers. If the user 125 does not select any of the service providers, the method 300 may end at block 330. If the user 125 selects a particular service provider such as the service provider, the method proceeds to block 340. At block 340, the server 120 receives a user selection of a service provider profile. The user selection may be received from the user device 110. The user selection may be initiated by various actions, including but not limited to, a gesture on a screen, a mouse selection, a keyboard selection, or a voice selection. For example, the server 120 may receive a user selection by the user 125 inputting a swipe on a touchscreen of the user device 110. The user selection may also include more than one service provider, for example if the initial task request had multiple parts. Further, a user selection of multiple service providers may designate each service provider to different aspects of the task.

At block 350, the server 120 sends the request to a provider device, e.g., the provider device 130a associated with the service provider 135a. The request may be in the form of a task assignment and include information relating to the user's task request. Additionally, or alternatively, the request may seek more information from the service provider 135a, negotiate a price, or ask to open further communications. For example, the user 125 may be requesting photography for a wedding and wants to ask a photographer service provider for recent examples of their work. After the server 120 sends the request, the service provider 135a may respond to the request. For example, the service provider 135a may accept, decline, ask questions to the user 125, or ignore the request.

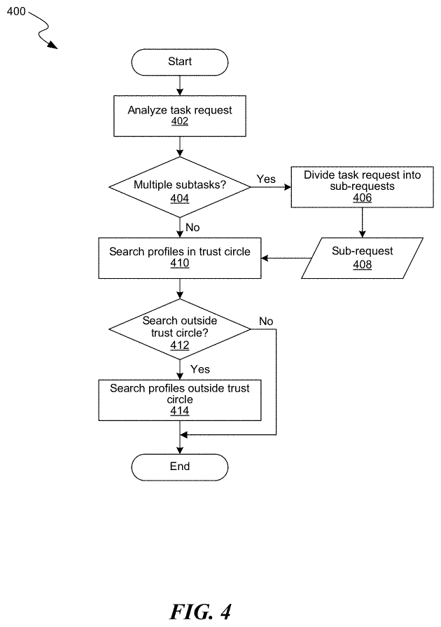

FIG. 4 shows a method 400 for searching service provider profiles, consistent with various embodiments. In some embodiments, the method 400 may be implemented using the system 100 of FIG. 1 and as part of block 320 in FIG. 3. The method 400 begins at block 402, where the server 120 analyzes the task request to extract the task parameters. The task parameters may include one or more of a price offered by the user 125 for a task, a location where the task should be performed, types of tasks, time requirements, level of expertise required, number of service providers required, and whether or not a trusted service provider is needed.

Using the task parameters, at determination block 404, the server 120 determines as to whether the task request comprises multiple subtasks. This may be based on an evaluation of the types of tasks, time requirements, location, and other parameters. For example, if a task request contains tasks that may not be completed by one service provider in one day, but the task parameters indicate that the task must be completed in two hours, it may be determined that the request comprises multiple subtasks. In another example, a task request comprises both picking up a coffee for the user 125 and transporting the user 125 to the airport. Although this request includes two types of tasks, they are relatively simple. If the location of the coffee shop is only a small detour from the route to the airport, therefore not significantly changing the time needed to reach the airport, then the task may remain undivided. In contrast, a task request requiring higher levels of expertise in different areas may be divided. For example, if a user is bit by a neighbor's dog, they may want to know if the bite can cause infection and whether or not they can sue their neighbor; a task request incorporating both questions may be divided into separate subtasks such as a first sub task of providing a medical advice and a second sub-task of providing a legal advice. The determination at block 404 may be made automatically, such as with machine learning algorithms, artificial intelligence, or manually, e.g., a human project manager. A task request may also explicitly specify multiple subtasks of the task.

If there are multiple subtasks in the task request, at block 406, the server 120 divides the task request into multiple sub-requests 408. The task parameters, including task types, time, location, expertise required, and other parameters are used to determine how to divide the task request. For example, a task request with multiple task types that cannot be performed simultaneously may be divided into sub-requests by task type. In another example, a task that would take one person four hours may be divided into four sub-requests if the task parameters indicate that the task should be completed in one hour.

If it's determined in block 404 that there are no multiple subtasks, then a search for service provider profiles in the trust circle is performed in block 410 using the single task request. If there are multiple sub-requests 408, a search may be performed for each sub-request. The search may prioritize service provider profiles that more closely match the user-provided task parameters, though it may return profiles that do not exactly match. For example, a search for Thai restaurant delivery may also return Cambodian restaurants.

At determination block 412, the server 120 determines as to whether a search should be performed for service providers outside the trust circle 200 based on the search criterion. For example, the search criterion can indicate that if there are no service providers who can perform the task in the trust circle, then the search should be expanded to outside the trust circle. In another example, the search criterion can indicate that a search may need to be performed outside the trust circle if not enough search providers in the trust circle (that is, the number of service providers in the trust circle who can perform the task is below a specified threshold) are available to perform the task for a desired price or at a requisite time. In other embodiments, the search criterion can indicate that the search outside the trust circle is to be performed by default. The user may also specify whether to search outside the trust circle when making a task request.

If the server 120 determines that search need not be performed outside the trust circle, the method 400 ends. On the other hand, if the server 120 determines that the search is to be performed outside the trust circle, at block 414, the search for profiles outside the trust circle is performed. The search 414 may be performed in the same manner as the search in block 410, except searching the set of service provider profiles outside the trust circle. Alternatively, the search block at 414 may differ from that of block 410 based on the task parameters, geographic region, or other factors.

After the method 400 ends, the server 120 can return to executing block 330 of FIG. 3 to transmit the search results, e.g., service provider profiles determined as part of the search, to the user device 110.

FIG. 4 only represents certain embodiments of matching the task to a person or group, and other embodiments may perform steps in a different order or include additional steps. For instance, searches of service provider profiles in block 410 and 414 may occur before the determination at block 404 and division at block 406. This may be appropriate during instances where the determination of whether a task has multiple subtasks in block 404 depends on which service providers are available. Performing a search beforehand allows the determination at block 404 to use service provider profile and user profile information, e.g., 141 and 142 in FIG. 1. Any number of additional searches and divisions may be performed this way to further refine results. In some embodiments, the searches 410 and 414, divisions 406, and presentations 416 may be performed dynamically to suggest additional profiles to user devices following the initial presentation of profiles, such as in the form of pop-up notifications.

### Managing a Trust Circle

FIG. 5 is a flow diagram of a method 500 for managing a trust circle, consistent with various embodiments. In some embodiments, the method 500 may be implemented using the system 100 of FIG. 1. The method 500 begins by detecting a breach 502 of a contractual, moral, or business obligation by a service provider 135a in the trust circle 200. These breaches may include, but are not limited to, being convicted of a crime, violating terms and conditions, missing more than a specified number of accepted task assignments, having a review rating lower than a specified threshold, or a negative report received from a user. The server 120 may detect the breach 502 automatically using input from various sources, e.g., the third-party systems 150.

At block 504, the server 120 classifies the breach into one of multiple categories, such as as “serious” or “minor.” In other embodiments, the breach may be assigned a numerical score. The breach may be classified by applying artificial intelligence to data from various sources, e.g., third-party systems 150, or based on an input received from an administrator of the task management application. These sources may include, but are not limited to, news reports, user reviews, social media, and court filings. These sources may also indicate the moral and ethical norms of the area where the service provider or user resides. In one example embodiment, the server 120 may be able to automatically parse public police records, e.g., using artificial intelligence, to determine how to classify a breach.

If the server 120 determines the breach as “minor,” at block 506, the server 120 removes the service provider 135a from the trust circle 200. In some embodiments, the service provider 135a is retained in the trust circle 200 for minor breaches but a trust rating of the service provider 135a may be decreased.

At block 508, even if the service provider 135a is removed from the trust circle 200, the server 120 can retain any connected service providers associated with the service provider 135a in the trust circle 200. A connected service provider is a service provider who is referred by a service provider in the trust circle 200 or one who referred the service provider into the trust circle 200. In the event the service provider 135a commits a “minor” breach, it may not reflect too poorly on the trust of the connected service providers, so the connected service providers may be retained.

For “serious” breaches, the server 120 removes the service provider 135a from the trust circle 200 at block 510. Following that, a connected service provider, e.g., service providers 221-223, is removed from the trust circle 200 at block 512. A “serious” breach calls into question the judgment of the trusted service provider in referring others and reflects poorly on the one who referred them, thus the removal of connected service providers. “Serious” breaches may include, for example, excessive missed appointments or felonies.

In some embodiments, the decision to remove or retain service providers is determined by a trust rating attributed to each trusted service provider in the trust circle. For example, service providers with a lower than threshold trust rating may be removed from the trust circle. This trust rating may be generated independently of connected service providers. For example, connected service providers may be retained in the trust circle if they have an above threshold trust rating, even if the service provider who referred them is removed because of a breach. In some embodiments, the trust rating may be related to the breach 502. For example, a “minor” breach may result in a decrease in a service provider's trust rating, and a “serious” breach may result in a larger decrease. Connected service providers may also have their trust rating decreased following a breach.

The trust rating may be generated according to various factors, including but not limited to, the amount of time the trusted service provider has been in the trust circle, information from reviews, such as review rating, the trusted service provider has received, the number of referrals the trusted service provider has received, or the trust rating of other service providers in the trust circle that are connected to the trusted service provider. For example, a long-time member of the trust circle with many positive reviews may have higher trust rating than a new member. Also, a member who's made many referrals of service providers with high trust ratings is more likely to also have a high trust rating. The trust rating may be generated according to these and other factors using machine learning.

Alternatively or additionally, a trusted service provider may be removed from a trust circle by user input.

### GUIs of Task Management App

FIG. 6A is screenshot of a search GUI 605 of the task management application, consistent with various embodiments. Using the search GUI 605, the user 125 can search for a variety of services and issue a task request. For example, the user 125 can input task details, such as “cutting the lawn” in the search GUI 605 to obtain service providers who provide lawn cutting services. The search GUI 605 can also display searches trending in a geographical area.

FIG. 6B is screenshot of a voice GUI 610 of the task management application, consistent with various embodiments. The voice GUI 610 displays a transcription of the task request issued by the user 125 as a voice command. The user 125 has provided a voice command for finding two different service providers—a veterinary doctor and an animal psychology consultant. The user 125 can also specify the price he/she is willing to pay for the service. Upon receiving the voice command, the task management application analyzes the voice command to extract the task parameters and performs a search accordingly.

FIG. 6C is screenshot of a chat GUI 615 of the task management application, consistent with various embodiments. The chat GUI 615 allows the user 125 to generate a task request via one or more chat messages. In some embodiments, the chat messages from the user 125 are received and interpreted into a task request by an artificial intelligence bot. In some embodiments, the chat messages from the user 125 are received and interpreted into a task request by a human operator such as a project manager. In the chat GUI 615, the user 125 has generated a task request for delivery of food and pick up of clothes from dry cleaning via multiple chat messages.

FIG. 7A is screenshot of a profile GUI 705 of the task management application, consistent with various embodiments. The profile GUI 705 displays a profile of the service provider such as lawn mowing service provider. The profile GUI 705 displays information such as a name of the service provider, service provider identification (ID), one or more pictures of the service provider, user rating of the service provider, number of times the service provider has provided the service via the task management application, scheduling options for scheduling an appointment, and the cost of the service.

FIG. 7B is screenshot of an extended profile GUI 710 of the task management application, consistent with various embodiments. The extended profile GUI 710 displays a profile of the service provider, such as lawn mowing service provider, in more detail than the profile GUI 705. As illustrated in FIG. 7B, the extended profile GUI 710 displays information such as other services offered by the service provider, a calendar showing availability of the service provider, and some service statistics in addition to the details displayed in the profile GUI 705. The user 125 can choose to assign the task to the service provider by selecting the “Hire” button in either the profile GUI 705 or the extended profile GUI 710.

### Example Computer System

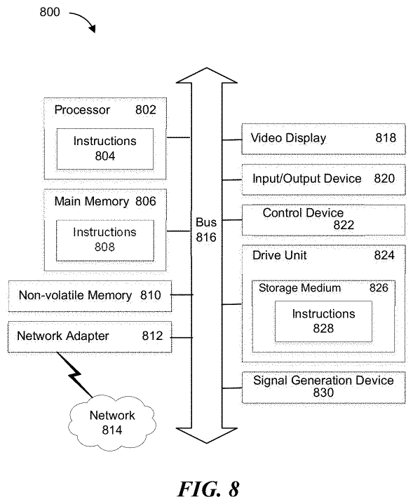

FIG. 8 is a block diagram illustrating an example of a processing system 800 in which the described embodiments can be implemented. Any of the entities, components, modules, processes, methods described herein can be implemented using the processing system 800. For example, one or more of the user device 110, server 120, service provider device 130, storage system 140, or third-party systems 150 may be implemented as the example processing system 800. The processing system 800 may include one or more central processing units (“processors”) 806, main memory 806, non-volatile memory 810, network adapter 812 (e.g., network interfaces), video display 818, input/output devices 820, control device 822 (e.g., keyboard and pointing devices), drive unit 824 including a storage medium 826, and signal generation device 830 that are communicatively connected to a bus 816. The bus 816 is illustrated as an abstraction that represents any one or more separate physical buses, point to point connections, or both connected by appropriate bridges, adapters, or controllers. The bus 816, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 494 bus, also called “Firewire.”

In various embodiments, the processing system 800 operates as part of a user device, although the processing system 800 may also be connected (e.g., wired or wirelessly) to the user device. In a networked deployment, the processing system 800 may operate in the capacity of a server or a client machine in a client-server network environment, or as a peer machine in a peer-to-peer (or distributed) network environment.

The processing system 800 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 800.

While the main memory 806, non-volatile memory 810, and storage medium 826 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 828. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 804, 808, 828) set at various times in various memory and storage devices in a computer, and that, when read and executed by one or more processing units or processors 802, cause the processing system 800 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 810, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 812 enables the processing system 800 to mediate data in a network 814 with an entity that is external to the processing system 800 through any known and/or convenient communications protocol supported by the processing system 800 and the external entity. The network adapter 812 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network adapter 812 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

From the foregoing, it will be appreciated that specific embodiments of the invention have been described herein for purposes of illustration, but that various modifications may be made without deviating from the scope of the invention. Accordingly, the invention is not limited except as by the appended claims.

I claim:

1. A method comprising:
receiving a task request from a user device associated with a user, the task request including task parameters;
searching multiple service provider profiles for a set of service providers in a trust circle associated with the user matching the task parameters,
the set of service providers in the trust circle including at least one of:
a primary service provider, the primary service provider being one of multiple service providers who has previously worked with the user,
a secondary service provider, the secondary service provider referred by one of the multiple service providers in the trust circle, or
a tertiary service provider, the tertiary service provider referred by a vetted individual; and
presenting the service provider profiles associated with the set of service providers to the user device.

2. The method of claim 1, wherein searching the multiple service provider profiles include:
receiving a referral of the secondary service provider from one of the service providers in the trust circle; and
adding the secondary service provider to the trust circle.

3. The method of claim 1, wherein searching the multiple service provider profiles include:
receiving a referral of the tertiary service provider from the vetted individual, the vetted individual including a specified user associated with the user in a social network; and
adding the tertiary service provider to the trust circle.

4. The method of claim 1 further comprising:
generating a breach classification associated with a breach of a contractual obligation, moral standard, or business obligation by a trusted service provider, the trusted service provider being one of the service providers in the trust circle; and
deciding whether to remove the trusted service provider from the trust circle according to the breach classification.

5. The method of claim 4 further comprising:
deciding whether to remove a connected service provider from the trust circle according to the breach classification, the connected service provider being either a service provider in the trust circle referred by the trusted service provider or a service provider in the trust circle who referred the trusted service provider.

6. The method of claim 5, wherein deciding whether to remove the trusted service provider from the trust circle:
in an event the breach classification is “serious,” removing the trusted service provider and the connected service provider from the trust circle.

7. The method of claim 5, wherein deciding whether to remove the trusted service provider includes:
retaining the trusted service provider in the trust circle if the breach classification is “minor”.

8. The method of claim 5, wherein deciding whether to remove the trusted service provider includes:
in an event the breach classification is “minor,”
removing the trusted service provider from the trust circle, and
retaining the connected service provider in the trust circle.

9. The method of claim 4, wherein the breach classification is generated according to one or more of:
the number of missed appointments the trusted service provider has accumulated,
whether the trusted service provider was convicted of a crime,
information from user reviews of the trusted service provider, or
information from news media.

10. The method of claim 4, wherein the breach classification is evaluated using artificial intelligence technique.

11. The method of claim 1 further comprising:
removing one of the service providers in the trust circle if no referrals are received from said service provider in a specified amount of time.

12. The method of claim 4 further comprising:
generating a trust rating associated with the trusted service provider; and
deciding whether to remove the trusted service provider from the trust circle according to the trust rating.

13. The method of claim 12, wherein deciding whether to remove the trusted service provider from the trust circle includes:
comparing the trust rating to a threshold rating, and
removing the trusted service provider from the trust circle if the trust rating is below the threshold rating.

14. The method of claim 12, wherein the trust rating is generated according to at least one of:
the amount of time the trusted service provider has been in the trust circle,
information from reviews the trusted service provider has received,
the number of referrals the trusted service provider has received from other service providers, or
the trust rating of other service providers in the trust circle referred by the trusted service provider.

15. The method of claim 1, wherein the task parameters include a task type, a price offered for a task, a time requirement, location information where the task has to be performed, a number of service providers required for the task, or a level of expertise required for the task.

16. The method of claim 1, wherein the task request is associated with more than one task type.

17. The method of claim 1, wherein the task request from the user device is received as a voice request.

18. The method of claim 1, wherein searching the multiple service provider profiles includes searching for a set of untrusted service providers outside the trust circle matching the task parameters.

19. The method of claim 1 further comprising:
receiving, from the user device, a user selection of a service provider from the set of service providers; and
sending a request to a provider device associated with the service provider.

20. The method of claim 1, wherein searching the multiple service provider profiles includes:
determining that the task request is associated with a task that has multiple sub-tasks,
dividing the task request into sub-requests, wherein each sub-request corresponds to one of the sub-tasks, and
assigning different sub-tasks to different service providers by sending the sub-requests to provider devices associated with the different service providers.

21. The method of claim 20, wherein assigning different sub-tasks to different service providers includes assigning the sub-tasks to service providers from the set of service providers that match task parameters associated with the sub-tasks.

22. A system comprising:
a processor; and
a memory storing instructions which, when executed by the processor, cause the system to:
receive a task request from a user device associated with a user, the task request including task parameters;
search multiple service provider profiles for a set of service providers in a trust circle associated with the user matching the task parameters, the set of service providers in the trust circle including at least one of:
a primary service provider, the primary service provider being one of multiple service providers who has previously worked with the user,
a secondary service provider, the secondary service provider referred by one of the multiple service providers included in the trust circle, or
a tertiary service provider, the tertiary service provider referred by a vetted individual; and
present the service provider profiles associated with the set of service providers to the user device.

23. A non-transitory computer-readable storage medium storing computer-readable instructions, comprising:
instructions for receiving a task request from a user device associated with a user, the task request including task parameters;
instructions for searching multiple service provider profiles for a set of service providers in a trust circle associated with the user matching the task parameters, the set of service providers in the trust circle including at least one of:
a primary service provider, the primary service provider being one of multiple service providers who has previously worked with the user,
a secondary service provider, the secondary service provider referred by one of the multiple service providers included in the trust circle, or
a tertiary service provider, the tertiary service provider referred by a vetted individual;
instructions for presenting the service provider profiles associated with the set of service providers to the user device;
instructions for receiving, from the user device, a user selection of a service provider from the set of service providers; and
instructions for sending a request to a provider device associated with the service provider.
